(19) United States
(12) Patent Application Publication
(10) Pub. No.: US 2019/0287284 A1
(43) Pub. Date: Sep. 19, 2019

(54) METHOD OF CREATING MOBILE APPLICATIONS

(71) Applicant: Ali Ispahany, Toronto (CA)

(72) Inventor: Ali Ispahany, Toronto (CA)

(21) Appl. No.: 15/923,678

(22) Filed: Mar. 16, 2018

(51) Int. Cl. G06T 11/60; G06F 3/0484; G06F 8/34

(52) U.S. Cl. CPC G06T 11/60; G06T 2200/24; G06F 8/34; G06F 3/04845

(57) ABSTRACT

A method of creating mobile applications includes the steps of providing a home screen as a single image, mapping for and overlaying action buttons for functionality, and assigning specific functions to the action buttons. This method is an improvement of the method of using multiple images and assigning functions to each image.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of electrical communications and more specifically relates to personal portable devices.

### 2. Description of Related Art

A very large portion of the population currently uses mobile devices, sometimes called smart phones. This kind of usage has created a need for many businesses to have a mobile application which can be used on mobile devices. While many mobile applications offer similar functionality, mobile applications are often custom made to provide the visual design and layout desired by the organization or individual requesting the mobile application. However, creating custom mobile applications having desired functionality, design, and structure frequently involves placing multiple images on a background and then adding functionality to each individual image. This can be a very time-consuming and laborious process.

Typically, mobile applications are made currently by starting with a background image, and then creating separate images for each desired action button, and then arranging the images with associated action buttons on the background image so that they form a cohesive interface. A more efficient and user-friendly solution is desired.

U.S. Pat. No. 7,982,598 to Michel Bonansea, et al. relates to a method for integrating user notifications and user alerts on an electronic device. The described method for integrating user notifications and user alerts on an electronic device includes an interface for integrating and presenting user notifications and alerts consistently on an electronic device such as a mobile device. First, an application programming interface provides the segregation to multiple preselected levels of priority notifications and alerts from all applications on the mobile device. Second, the application programming interface provides for the ability to display the notifications and alerts in a consistent manner for the user to handle.

### BRIEF SUMMARY OF THE INVENTION

In view of the foregoing disadvantages inherent in the known communications electrical art, the present disclosure provides a novel method of creating mobile applications. The general purpose of the present disclosure, which will be described subsequently in greater detail, is to provide a method of creating mobile applications by overlaying action buttons over a single image.

A method is also disclosed herein. The method includes the steps of: providing a home screen as a single image; mapping for and overlaying action buttons for functionality without restriction on relative placement of the action buttons on the single image; and assigning a specific-function to each of the action buttons.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a method of creating mobile applications, constructed and operative according to the teachings of the present disclosure.

FIG. 1 is a view of the method, according to an embodiment of the disclosure.

FIG. 2 is a view of the method of FIG. 1, according to an embodiment of the present disclosure.

FIG. 3 is a view of the method of FIG. 1, according to an embodiment of the present disclosure.

FIG. 4 is a view of the method of FIG. 1, according to an embodiment of the present disclosure.

FIG. 5 is another view of the method, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to electrical communications and more particularly to a method of creating mobile applications as used to improve the use of personal portable devices.

Generally, since mobile applications are currently made by starting with a background image, and then creating separate images for each desired action button, and then arranging the images with associated action buttons on the background image so that they form a cohesive interface, the solution provided via this new method starts by creating a home screen as a single image rather than multiple individual images, and then mapping and overlaying action buttons for functionality on top of the single home screen image. These action buttons can be configured for any desired function and can be placed and re-sized as desired.

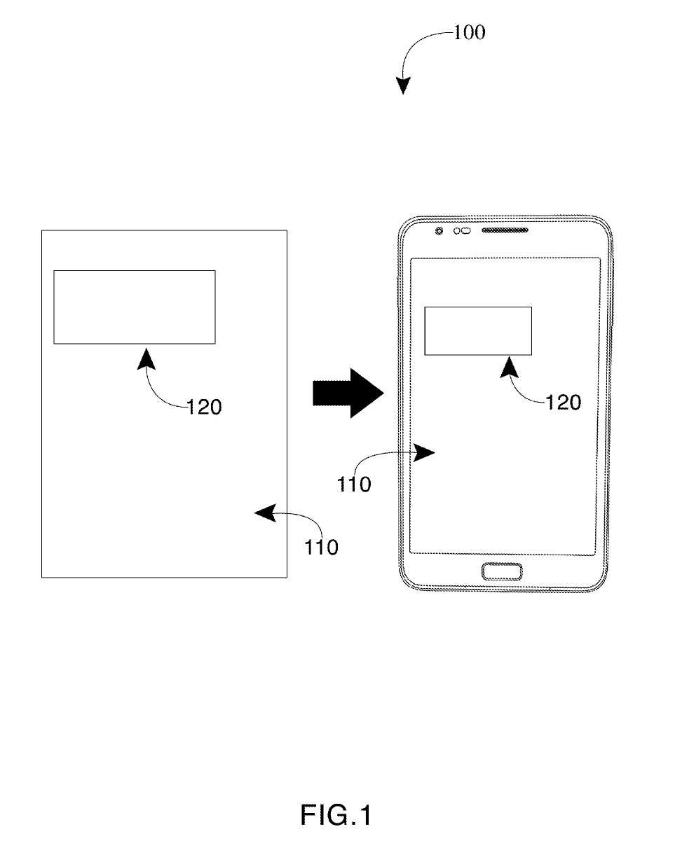

Referring now more specifically to the drawings by numerals of reference, there is shown in FIGS. 1-5, various views of a method for creating a mobile application 100. FIG. 1 shows a method for creating a mobile application 100, according to an embodiment of the present disclosure. As Illustrated, the method for creating a mobile application 100 may include the steps of: providing a home screen as a single image 110, mapping for and overlaying action buttons 120, and assigning a specific-function to each of the action buttons 120. Mapping for and overlaying the action buttons 120 for functionality is done without restriction on relative placement of the action buttons 120 on the single image 110.

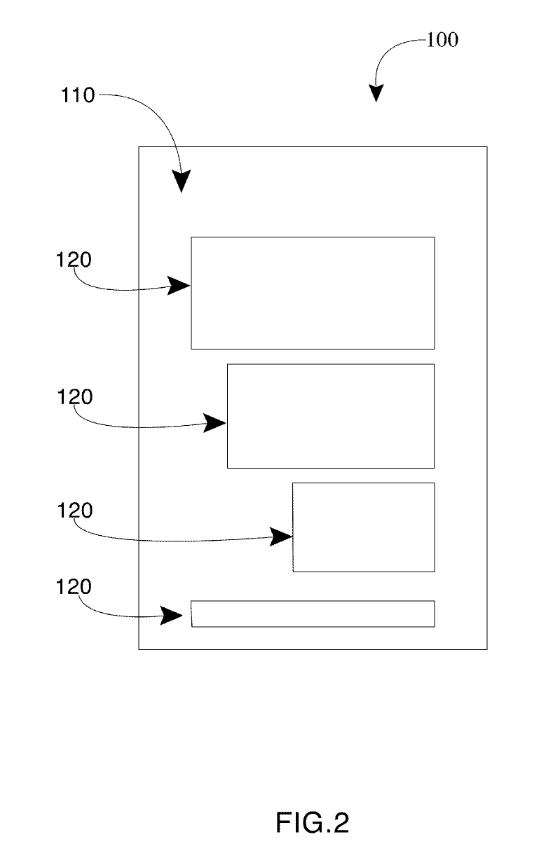

FIG. 2 shows a view of the method for creating a mobile application 100 of FIG. 1, according to an embodiment of the present disclosure. As above, the method 100 may include the steps of: providing a home screen as a single image 110, mapping for and overlaying action buttons 120 for functionality on the single image 110, and assigning a specific-function to each of the action buttons 120. Once an action button 120 has been overlaid on a home screen single image 110, the action box can be adjusted in size or shape. If multiple action buttons 120 have been overlaid on a single image 110, each action box 120 can be sized independently. Each action button 120 can be sized for length, width, height, or any combination of length, width, and height. In this way the present invention lends itself to excellent functionality and ease of customization in a user-friendly format.

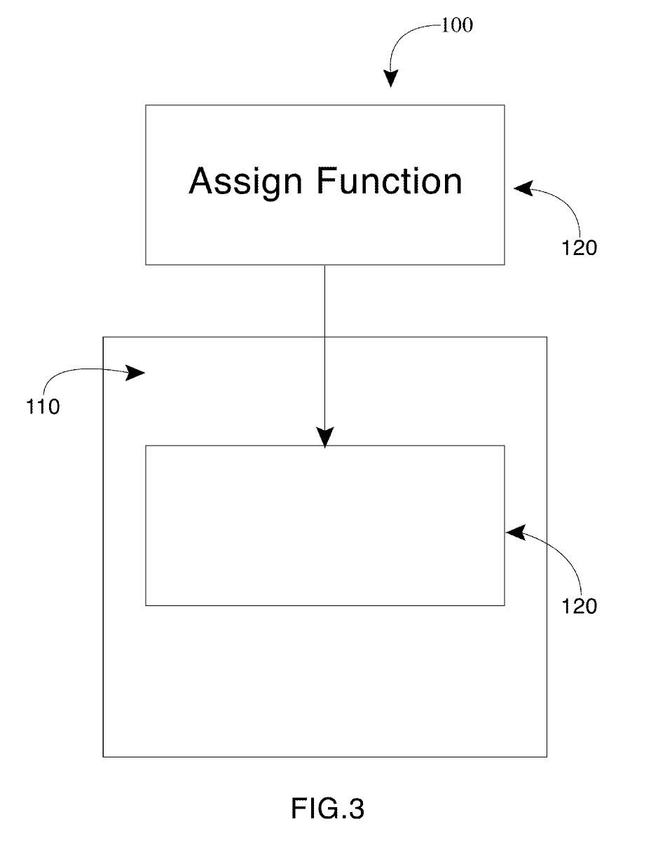

Referring now to FIG. 3 showing a view of the method for creating a mobile application 100 of FIG. 1, according to an embodiment of the present disclosure. As above, the method 100 may include the steps of: providing a home screen as a single image 110, mapping for and overlaying action buttons 120 for functionality on the single image 110, and assigning a specific-function to each of the action buttons 120. The desired functions assigned to an action button 120 may be associated with items such as a calendar, call us, employee schedule, fan walls, form, image gallery, information tab, notification, points, profile, punch card, punch card (single), queue, redeem, refer friend, reward level, scratch card, settings, and shopping cart. In addition to the aforementioned options, specific functions can be custom created as needed. The list provided is for exemplary means and is not intended to be limiting in any way.

With the functionality being assigned to an action button 120, this means that functions are not assigned to the single image 110 in a specific position of where a function may have a visual representation. While the single image 110 is able to include a background image and visual representations of desired functions, when an action button 120 is overlaid onto the single image 110 they become virtually-integral. Even after placement, the assigned function of an action button 120 can be changed to a different function as desired. It is also possible to place multiple action buttons 120 onto a single image 110, with each action button 120 having a function assigned to it.

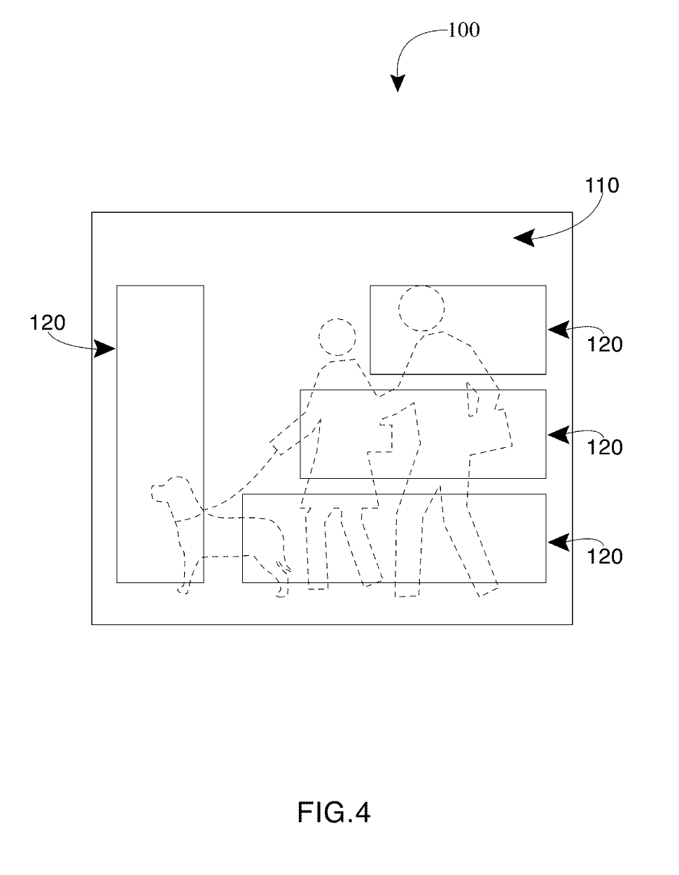

FIG. 4 shows another view of the method for creating a mobile application 100 of FIG. 1, according to an embodiment of the present disclosure. As above, the method 100 may include the steps of: providing a home screen as a single image 110, mapping for and overlaying action buttons 120 for functionality on the single image 110, and assigning a specific-function to each of the action buttons 120. The single image 110 serves as a background for the mobile application and may also contain the visual representations of specific desired functions. This means that the single image 110 is not used solely as a background, but rather a background with places for action buttons 120. Additionally, the single image 110 may be scrollable, allowing it to be larger than the initially viewable area of a mobile device. Action buttons 120 may be placed and sized to correspond with visual representations of desired functions so that a user is able to perform the function as indicated by the visual representation when using the created mobile application.

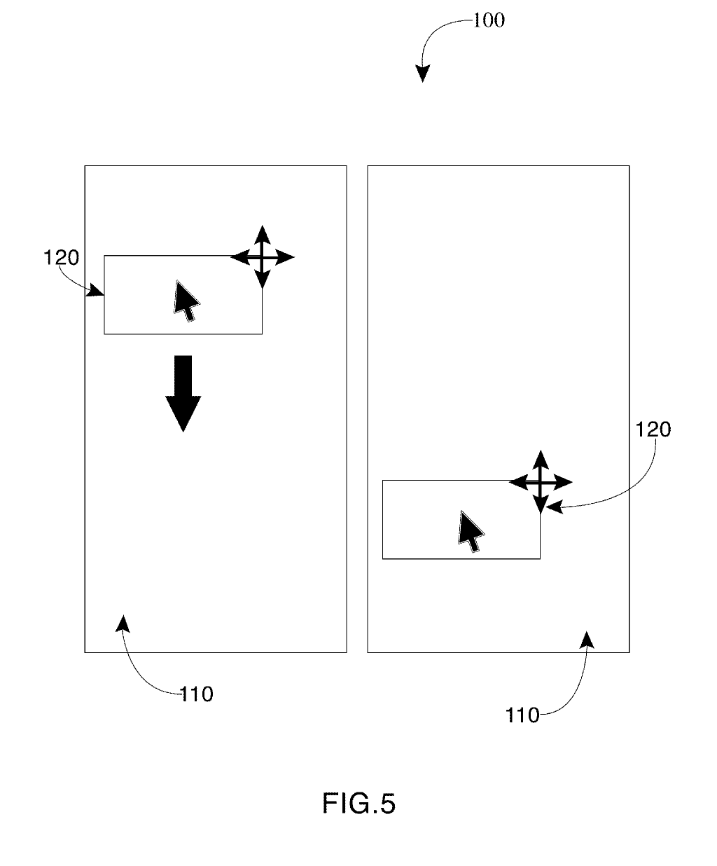

FIG. 5 shows another view of the method for creating a mobile application 100 of FIG. 1, according to an embodiment of the present disclosure. As above, the method 100 may include the steps of: providing a home screen as a single image 110, mapping for and overlaying action buttons 120 on the single image 110, and assigning a specific-function to each of the action buttons 120. When an action button 120 has been placed on a single image 110, the action button can be positioned anywhere on the single image 110 on an XY axis.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method for creating a mobile application comprising the steps of:
providing a home screen as a single image;
mapping for and overlaying action buttons for functionality without restriction on relative placement of said action buttons on said single image; and
assigning a specific-function to each of said action buttons.

2. The method for creating a mobile application of claim 1, wherein said single image is able to comprise multiple said action buttons to perform specified-functions.

3. The method for creating a mobile application of claim 1, wherein a function is not assigned to said single image in a specified positioning only.

4. The method for creating a mobile application of claim 1, wherein a function is assigned to each said action button.

5. The method for creating a mobile application of claim 1, wherein the single image is scrollable.

6. The method for creating a mobile application of claim 1, wherein the single image is not used solely as a background.

7. The method for creating a mobile application of claim 6, wherein the single image and said action button are virtually-integral.

8. The method for creating a mobile application of claim 1, wherein the action button(s) are able to be manipulated positionally throughout an XY axis.

9. The method for creating a mobile application of claim 1, wherein the action button(s) are able to be manipulated functionally between different said specific-functions.

10. The method for creating a mobile application of claim 1, wherein the action buttons are able to be independently sized.

11. The method for creating a mobile application of claim 10, wherein the action buttons are able to be independently sized for length.

12. The method for creating a mobile application of claim 10, wherein the action buttons are able to be independently sized for width.

13. The method for creating a mobile application of claim 10, wherein the action buttons are able to be independently sized for height.

14. The method for creating a mobile application of claim 10, wherein the action buttons are able to be independently sized for length, width and height.

15. The method for creating a mobile application of claim 4, wherein the specific-function assigned to the action button is selected from the group consisting of calendar, call us, employee schedule, fan walls, form, image gallery, information tab, notification, points, profile, punch card, punch card (single), queue, redeem, refer friend, reward level, scratch card, settings, and shopping cart.

16. The method for creating a mobile application of claim 4, wherein the specific function assigned to the action button is a custom function created as needed.

17. A method for creating a mobile application, the method for creating a mobile application comprising: providing a home screen as a single image;
mapping for and overlaying action buttons for functionality without restriction on relative placement of said action buttons on said single image; and
assigning a specific function to each of said action buttons; and
wherein said single image is able to comprise multiple said action buttons to perform specified functions;
wherein a function is assigned to each said action button;
wherein the single image is scrollable;
wherein the single image is not used solely as a background;
wherein the action button(s) are able to be manipulated positionally throughout an XY axis;
wherein the action button are able to be independently sized;
wherein the action button are able to be independently sized for length;
wherein the action button are able to be independently sized for width;
wherein the action button are able to be independently sized for height; and
wherein the function assigned to the action button is a custom function created as needed.
